(19) United States
(12) Patent Application Publication
(10) Pub. No.: US 2013/0004827 A1
(43) Pub. Date: Jan. 3, 2013

(54) NONAQUEOUS ELECTROLYTE SECONDARY BATTERY

(75) Inventors: Shinya Miyazaki, Naruto-shi (JP); Kazunori Donoue, Sumoto-shi (JP); Hitoshi Maeda, Sumoto-shi (JP)

(73) Assignee: SANYO ELECTRIC CO., LTD., Osaka (JP)

(21) Appl. No.: 13/535,982

(22) Filed: Jun. 28, 2012

(30) Foreign Application Priority Data
Jun. 30, 2011 (JP) 2011-146345

(51) Int. Cl. H01M 10/05; H01M 2/16

(52) U.S. Cl. 429/145; 429/153

(57) ABSTRACT

Provided is a nonaqueous electrolyte secondary battery. The stacked electrode assembly contains positive electrode plates in which no positive electrode active material layer is formed on at least one side of the positive electrode substrate and negative electrode plates in which no negative electrode active material layer is formed on at least one side of the negative electrode substrate. Such positive electrode surfaces where no positive electrode active material layer is formed are opposed, with a separator interposed, to such negative electrode surfaces where no negative electrode active material layer is formed. The separator interposed between the positive electrode active material layers and negative electrode active material layers has a layer containing ceramic. The separator interposed between the surfaces where no positive electrode active material layer is formed and the surfaces where no negative electrode active material layer is formed has no layer containing ceramic.

### TECHNICAL FIELD

The present invention relates to a nonaqueous electrolyte secondary battery that is equipped with a stacked electrode assembly in which positive electrode plates and negative electrode plates are stacked with a separator interposed.

### BACKGROUND ART

In recent years, nonaqueous electrolyte secondary batteries such as lithium ion batteries have come to be used not only as power sources for cellular phones, notebook personal computers, PDA's and other mobile data terminals, but also in robots, electric vehicles, backup power sources, etc., and hence are being required to have even higher capacity and higher energy density.

Broadly speaking, nonaqueous electrolyte secondary batteries take two forms: a cylindrical form in which a wound-type electrode assembly is sealed in a bottomed cylindrical outer covering, and a prismatic form in which a stacked electrode assembly of stacked multiple rectangular electrode plates, or a flattened wound-type electrode assembly, is sealed in a bottomed square-tubular outer covering or laminate outer covering.

For high-capacity applications such as robots, electric vehicles, and backup power sources, multiple single batteries are used connected in series and/or in parallel as a battery pack. In these cases, enhanced high output in a restricted space is required, and so rather than the cylindrical batteries, the prismatic batteries, which have superior energy density, are advantageous. In addition, for such prismatic batteries, it is advantageous to use stacked electrode assemblies with multiple electrode plates stacked together, in order to render the batteries large-size.

However, the safety of a nonaqueous electrolyte secondary battery tends to fall as its capacity and energy density are enhanced. Therefore, further improvement of safety for high capacity, high energy density nonaqueous electrolyte secondary batteries is being sought.

As technology for improving the safety of the batteries, JP-A-2001-68156 discloses a stacked polymer electrolyte battery comprising a stacked electrode group of positive electrodes with a positive electrode mixture layer formed on at least one side of the positive electrode collector, and negative electrodes with a negative electrode mixture layer formed on at least one side of the negative electrode collector, stacked alternately with polymer electrolyte layers interposed; and an outer covering that includes metal foil and houses the stacked electrode group. A short-circuiting and heat release promoting unit formed from two metal plates of thickness 30 μm or greater, disposed with an insulating body interposed between them, is provided on the outside of one or both of the outermost-layer electrodes of the stacked electrode group, each metal plate of the short-circuiting and heat release promoting unit being connected to the lead portion of an electrode of differing polarity, so as to provide a stacked polymer electrolyte battery that is high in safety and is prevented from emitting smoke or igniting, even if short-circuited by being pierced by a nail or crushed, etc.

JP-A-8-264206 discloses technology that provides a lithium ion secondary battery whose safety is assured even if a short-circuit should occur between its positive electrode active material and negative electrodes due to abnormal heating or crushing force in the stacking direction from the exterior, or to being pierced by a nail, etc. More specifically, a nonaqueous battery is disclosed that includes, inside a battery can, a stacked assembly of electrode plates, composed of: positive electrode plates having positive electrode active material on a single side only of the collector foil; negative electrode plates having negative electrode active material on a single side only of the collector foil; separators; and insulators. The unit battery layers, in which the positive electrode surface that has the positive electrode active material and the negative electrode surface that has the negative electrode active material are disposed opposing each other with a separator interposed, are stacked with insulators interposed.

Although the safety of nonaqueous electrolyte secondary batteries is improved by the technology in JP-A-2001-68156 and JP-A-8-264206, further improvement of safety will be desirable in cases where nonaqueous electrolyte secondary batteries are rendered even higher in capacity and energy density.

### SUMMARY

An advantage of some aspects of the present invention is to provide, with the aim of improving the safety of nonaqueous electrolyte secondary batteries, a nonaqueous electrolyte secondary battery that is prevented from emitting smoke, igniting or bursting, even if short-circuited by being pierced by a nail or crushed, etc.

According to an aspect of the invention, a nonaqueous electrolyte secondary battery includes a stacked electrode assembly in which positive electrode plates with positive electrode active material layers formed on both sides of a positive electrode substrate and negative electrode plates with negative electrode active material layers formed on both sides of a negative electrode substrate are stacked with a separator interposed, nonaqueous electrolyte, and an outer covering housing the stacked electrode assembly and the nonaqueous electrolyte. The stacked electrode assembly contains positive electrode plates in which no positive electrode active material layer is formed on at least one side of the positive electrode substrate and negative electrode plates in which no negative electrode active material layer is formed on at least one side of the negative electrode substrate; such positive electrode surfaces where no positive electrode active material layer is formed are opposed, with a separator interposed, to such negative electrode surfaces where no negative electrode active material layer is formed; the separator that is interposed between the positive electrode active material layers and negative electrode active material layers has a layer containing ceramic; and the separator that is interposed between the surfaces where no positive electrode active material layer is formed and the surfaces where no negative electrode active material layer is formed has no layer containing ceramic.

“Positive electrode plates in which no positive electrode active material layer is formed on at least one side of the positive electrode substrate” means those in which the positive electrode substrate has a positive electrode active material layer formed on one only of its sides, and those in which neither side of the positive electrode substrate has a positive electrode active material layer formed on it. Likewise, “negative electrode plates in which no negative electrode active material layer is formed on at least one side of the negative electrode substrate” means those in which the negative electrode substrate has a negative electrode active material layer formed on one only of its sides, and those in which neither side of the negative electrode substrate has a negative electrode active material layer formed on it.

If a nonaqueous electrolyte secondary battery equipped with a stacked electrode assembly short-circuits due to piercing from the exterior by a nail, etc., there is risk that due to the heat release caused by the short-circuit current, thermolytic reactions in the nonaqueous electrolyte or degradative reactions between the active material and the nonaqueous electrolyte will occur, leading to emission of smoke, ignition, or other trouble.

With this invention, portions are formed where the exposed side, where no positive electrode active material layer is formed, of a positive electrode substrate of a positive electrode plate, and the exposed side, where no negative electrode active material layer is formed, of a negative electrode substrate of a negative electrode plate, are opposed with a separator interposed. The separator interposed between exposed sides of positive electrode substrates and exposed sides of negative electrode substrates is a ceramic layer-less separator. Thereby, if a short-circuit due to piercing from the exterior by a nail, etc., occurs, the separator interposed between positive electrode substrates and negative electrode substrates will quickly thermally contract due to the heat release from the short-circuited portions, and then the positive electrode substrates and negative electrode substrates around the short-circuited portions will contact at their surfaces and short-circuit current will flow, so that battery voltage quickly falls. In addition, the separator interposed between positive electrode active material layers and negative electrode active material layers is a ceramic layer-containing separator, which means that even if the short-circuited portions release heat, the separator will be unlikely to contract, and the positive electrode active material layers and the negative electrode active material layers will not directly contact, so that passage of the short-circuit current through the active material layers can be curbed. Thus, even if a short-circuit occurs due to piercing by a nail, the positive electrode substrates and negative electrode substrates will contact at their surfaces and the battery voltage will fall, and moreover, the short-circuit current can be curbed from flowing into the active material layers, which means that emission of smoke, ignition or the like abnormality can be prevented from occurring.

With this invention, electrode plates with an active material layer formed on both sides of the substrate, electrode plates with an active material layer formed on one side only of the substrate, and electrode plates with no active material layer formed on both sides of the substrate, are all electrically connected to a terminal of corresponding polarity.

It is preferable that a portion where a surface on which no positive electrode active material layer is formed and a surface on which no negative electrode active material layer is formed are opposed with a separator interposed be located at one or both of the outermost portions, in the stacking direction, of the stacked electrode assembly. It is more preferable that such a portion where a surface on which no positive electrode active material layer is formed and a surface on which no negative electrode active material layer is formed are opposed with a separator interposed be located at both of the outermost portions, in the stacking direction, of the stacked electrode assembly.

With such portions where exposed sides, where no positive electrode active material layer is formed on the positive electrode substrate, of positive electrode plates, and exposed sides, where no negative electrode active material layer is formed on the negative electrode substrate, of negative electrode plates, are opposed with a separator interposed, being located at the outermost portions, in the stacking direction, of the stacked electrode assembly; then if piercing by a nail occurs, short-circuiting will occur primarily at such portions where exposed sides of positive electrode substrates and exposed sides of negative electrode substrates are opposed with a separator interposed, and so the short-circuit current will be more effectively curbed from flowing into the active material layers.

It is preferable that at the outermost portions, in the stacking direction, of the stacked electrode assembly, an electrode plate of one polarity with an active material layer formed on one side only of the substrate, and an electrode plate of the other polarity with no active material layer formed on both sides of the substrate, be stacked, with a separator interposed, in the order from inward to outward; and that the active material layer of the electrode plate of the one polarity with an active material layer formed on one side only of the substrate be opposed, with a separator interposed, to an active material layer formed on an electrode plate of the other polarity that is located inward in the stacking direction of the stacked electrode assembly.

In this way, an electrode plate of the one polarity with an active material layer formed on one side only of the substrate is disposed so that its active material layer is opposed, with a separator interposed, to the active material layer of an electrode plate of the other polarity that is located inward in the stacking direction of the stacked electrode assembly. On its outside, there is further disposed, with a separator interposed, an electrode plate of the other polarity with no active material layer formed on both sides of the substrate. Thereby, the safety can be improved, and moreover, reduction of the battery capacity can be avoided. Such configuration may be provided at one of the outermost portions, in the stacking direction, of the stacked electrode assembly, but is preferably provided at both such outermost portions.

It is preferable that at the outermost portions, in the stacking direction, of the stacked electrode assembly, an electrode plate of one polarity with an active material layer formed on one side only of the substrate, an electrode plate of the other polarity with no active material layer formed on both sides of the substrate, and an electrode of the one polarity with no active material layer formed on both sides of the substrate, be stacked, with separators interposed, in the order from inward to outward, and that the active material layer of the electrode plate of the one polarity with an active material layer formed on one side only of the substrate be opposed, with a separator interposed, to an active material layer formed on an electrode plate of the other polarity that is located inward in the stacking direction of the stacked electrode assembly.

Thereby, surfaces on which no active material layer is formed and which belong to electrode plates of the one polarity are disposed, with a separator interposed, on both sides of the electrode plate of the other polarity with no active material layer formed on both sides of the substrate, and consequently the battery voltage can be made to fall more quickly in the event of a short-circuit. Thanks to the use of an electrode of the one polarity with an active material layer formed on one side only of the substrate, falling of the battery capacity can be avoided. Such configuration may be provided at one of the outermost portions, in the stacking direction, of the stacked electrode assembly, but is preferably provided at both such outermost portions.

In the invention, the ceramic layer-containing separator is preferably a microporous film made of polyolefin.

If the separator is a microporous film made of polyolefin, it quickly thermally contracts in response to heat release from the short-circuited portions, and so the positive electrode substrates and negative electrode substrates can quickly be made to contact at their surfaces. It is preferable that polyethylene (PE), polypropylene (PP) or the like be used for the microporous films made of polyolefin. It is also preferable that a microporous film made of polyolefin that have porosity of 35% or higher be used. Furthermore, the microporous film made of polyolefin may be an item with a single layer or an item composed of multiple layers, such as PP+PE, PE+PP+PE, and so forth.

In the invention, the ceramic layer-containing separator is preferably provided with a layer composed of ceramic and binder on one or both faces of a microporous film made of polyolefin.

By providing the ceramic layer-containing separator with a layer composed of ceramic and binder on one or both faces of the microporous film made of polyolefin, a nonaqueous electrolyte secondary battery can be obtained that has superior battery characteristics and also superior safety.

It is preferable that the aforementioned ceramic be one or more items selected from the group consisting of alumina, silica and titania. It is also preferable that the ceramic be contained in particulate form in the layer. It is preferable that the particulate diameter be on the order of 0.1 to 3 μm. For the binder, a conveniently handleable resin binder is preferable as there is no particular restriction on the type of such. For the resin binder one could use, for example, a polyolefin such as polyethylene or polypropylene; a styrene-butadiene copolymer or hydride thereof; an acrylonitryl-butadiene copolymer or hydride thereof; an acrylonitryl-butadiene-styrene copolymer or hydride thereof; a rubber such as ethylenepropylene rubber, polyvinyl alcohol or polyvinyl acetate; or a cellulose derivative such as ethyl cellulose, methyl cellulose, or carboxymethyl cellulose. Of these, it is particularly preferable that polyvinyl alcohol be used. It is preferable that the proportion of the ceramic-containing layer that is accounted for by ceramic be on the order of 50 to 95% by mass, and more preferable that it be on the order of 60 to 90% by mass.

In addition to ceramic and binder, the ceramic-containing layer may also be made to contain lithium carbonate, lithium phosphate or the like.

In the invention, it is preferable that a portion where a surface on which no positive electrode active material layer is formed and a surface on which no negative electrode active material layer is formed are opposed with a separator interposed be formed also in a central region, in the stacking direction, of the stacked electrode assembly.

With portions where exposed sides, where no positive electrode active material layer is formed on the positive electrode substrate, of positive electrode plates, and exposed sides, where no negative electrode active material layer is formed on the negative electrode substrate, of negative electrode plates, are opposed, with a separator interposed, being present in the central region, in the stacking direction, of the stacked electrode assembly, as well as being present at the outermost portions in the stacking direction, the number of places where positive electrode substrates and negative electrode substrates will contact at their surfaces in the event of short-circuiting due to piercing by a nail, etc., will be increased, and so it will be possible to lower the battery voltage more instantaneously, thus improving the safety. This will be useful for nonaqueous electrolyte secondary batteries that have high battery capacity.

The invention is particularly advantageous in cases where the outer covering is a laminate outer covering.

The invention is particularly advantageous in cases where the nonaqueous electrolyte secondary battery has a capacity of not less than 10 Ah and a thickness of not more than 15 mm.

With a battery that has a small thickness and a large capacity, if short-circuiting occurs due to piercing by a nail, etc., it will take time for the battery voltage to fall after short-circuit current flows via the nail. Therefore, more short-circuit current will flow into the active material layers also, and so the battery will be liable to emit smoke or ignite. Hence, it will be more advantageous if the invention is applied to a battery that has a small thickness and a large capacity.

In the invention, it is preferable that 10 or more positive electrode plates with positive electrode active material layers formed on both sides of the positive electrode substrate, and 10 or more negative electrode plates with negative electrode active material layers formed on both sides of the negative electrode substrate, be included.

Thereby, a nonaqueous electrolyte secondary battery can be obtained that has high capacity and energy density.

In this invention, if the ceramic layer-containing separator is an item in which a layer composed of ceramic and binder is provided on one side only of a microporous film of polyolefin, then it is preferable that the layer composed of ceramic and binder be disposed so as to be opposed to the negative electrode active material layers of the negative electrode plates.

With layers composed of ceramic and binder that readily capture electrolyte positioned at the negative electrode plates, ample electrolyte can be made to be present at the negative electrode plates. Hence, the insertability of the lithium ions into the negative electrode active material can be improved and the battery has superior cycling characteristics.

### BRIEF DESCRIPTION OF THE DRAWINGS

The invention will be described with reference to the accompanying drawings, wherein like numbers reference like elements.

FIG. 1 is a perspective view of a prismatic lithium ion battery of the invention.

FIG. 2 is a perspective view of a stacked electrode assembly used in a prismatic lithium ion battery of the invention.

FIG. 3A is a top view of a positive electrode plate used in a prismatic lithium ion battery of the invention.

FIG. 3B is a top view of a negative electrode plate used in a prismatic lithium ion battery of the invention.

FIG. 4 is a side view of a stacked electrode assembly used in the prismatic lithium ion battery of Example 1 of the invention.

FIG. 5 is a side view of a stacked electrode assembly used in the prismatic lithium ion battery of Example 2 of the invention.

FIG. 6 is a side view of a stacked electrode assembly used in the prismatic lithium ion battery of Example 3 of the invention.

### DESCRIPTION OF EXEMPLARY EMBODIMENTS

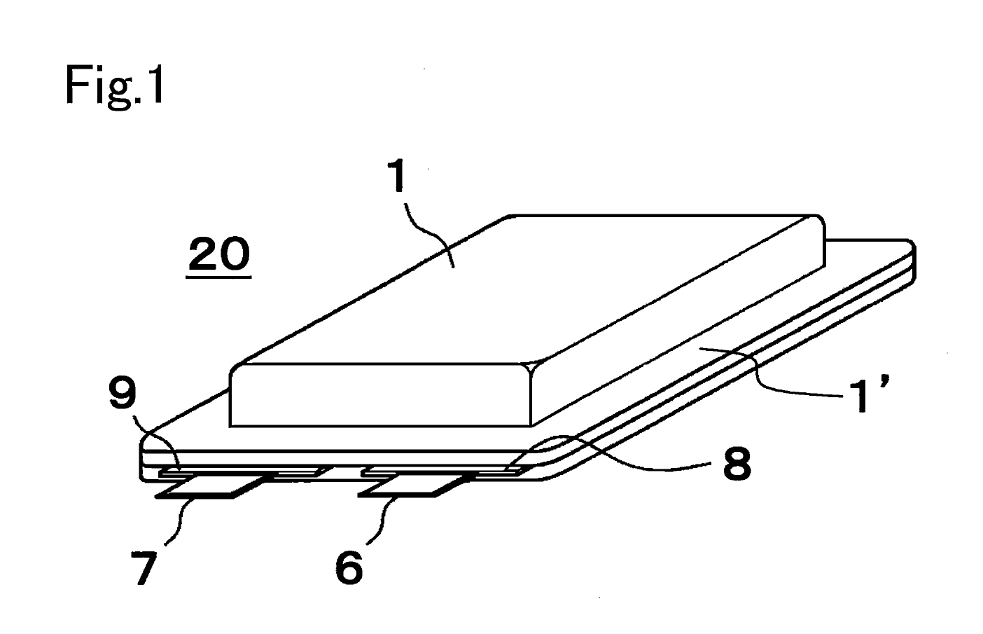

Prismatic lithium ion batteries will now be described with reference to the accompanying FIGS. 1 to 3, as exemplary embodiments of a nonaqueous electrolyte secondary battery of the invention. However, it should be understood that the embodiments set forth below are intended by way of examples for understanding the technical concepts of the invention, and not by way of limiting the invention to these particular nonaqueous electrolyte secondary batteries. The invention can be applied appropriately to yield many variants without departing from the scope and spirit of the claims.

First will be described, with reference to FIG. 1, a prismatic lithium ion battery 20 of the invention. As FIG. 1 shows, in the prismatic lithium ion battery 20 of the invention, a stacked electrode assembly 10 is housed together with electrolyte inside a laminate outer covering 1, and a positive electrode terminal 6 and negative electrode terminal 7, connected to a positive electrode collector tab 4 and negative electrode collector tab 5 respectively, protrude from the seal-welded portion 1′ of the laminate outer covering 1. On the seal-welded portion 1′ of the laminate outer covering 1, a positive electrode tab plastic piece 8 and negative electrode tab plastic piece 9 are disposed between the laminate outer covering 1 and the positive electrode terminal 6 and negative electrode terminal 7, respectively. The positive electrode tab plastic piece 8 and negative electrode tab plastic piece 9 are disposed with the purpose of improving airtightness between the tabs and laminate outer covering, and of preventing short-circuiting between the tabs and the metallic layers composing the laminate outer covering.

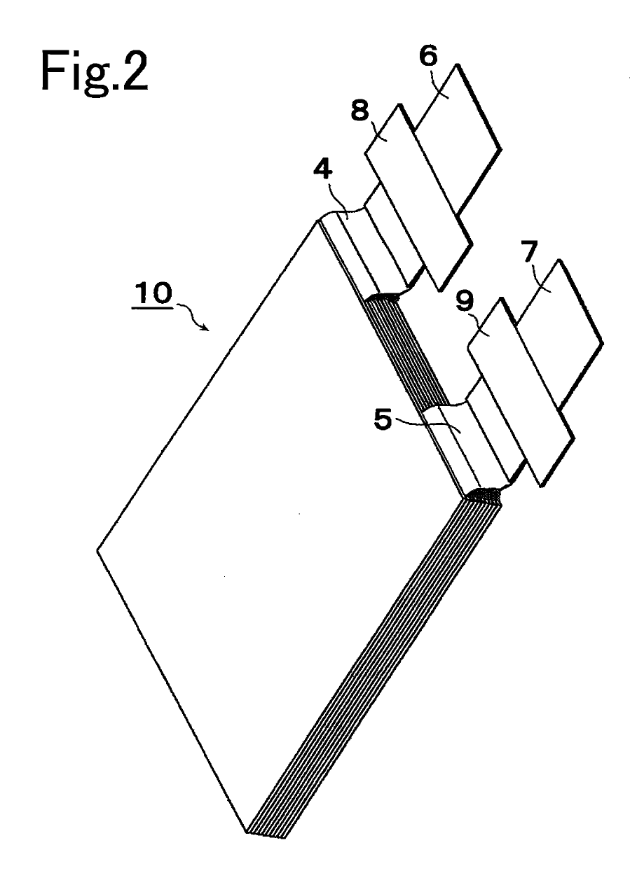

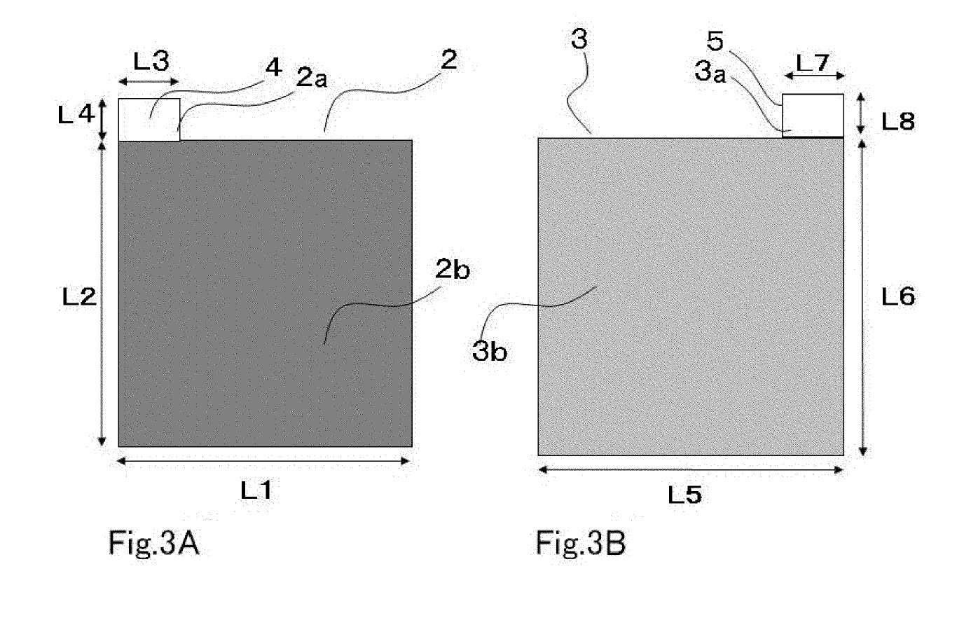

Next will be described, with reference to FIGS. 2 and 3, the stacked electrode assembly 10 used in the prismatic lithium ion battery 20 of the invention. The stacked electrode assembly 10, which is housed inside the laminate outer covering 1, has positive electrode plates 2 (omitted from the drawings) and negative electrode plates 3 (omitted from the drawings) stacked alternately with separators 11 (omitted from the drawings) interposed, as shown in FIG. 2.

As FIG. 3A shows, in the positive electrode plate 2, a positive electrode active material layer 2b is formed on both sides of a positive electrode substrate 2a, and from one end a portion of the positive electrode substrate 2a where no positive electrode active material 2b is formed protrudes as a positive electrode collector tab 4. Likewise, as FIG. 3B shows, in the negative electrode plate 3, a negative electrode active material layer 3b is formed on both sides of a negative electrode substrate 3a, and from one end a portion of the negative electrode substrate 3a where no negative electrode active material 3b is formed protrudes as a negative electrode collector tab 5.

In the invention, a portion of the positive electrode substrate 2a and of the negative electrode substrate 3a can be used unaltered as the positive electrode collector tab 4 and negative electrode collector tab 5, in the manner described above. Alternatively, separate collector tabs could be respectively connected to the positive electrode substrate 2a and negative electrode substrate 3a.

In the stacked electrode assembly 10, the positive electrode collector tabs 4 and negative electrode collector tabs 5 protruding from the electrode plates are stacked up and connected by ultrasonic welding, resistance welding or the like to a positive electrode terminal 6 and a negative electrode terminal 7, respectively.

The stacked electrode assembly 10 is inserted between a laminate film, which has been cup-formed so as to house the stacked electrode assembly 10, and a sheet-form laminate film, and three of the outer edges are thermally welded so that the positive electrode collector tabs 4 and negative electrode collector tabs 5 protrude out of the seal-welded portion 1′ of the laminate outer covering 1. After that, nonaqueous electrolyte is poured in through the mouth portion, where no thermal welding has been performed, in the laminate outer covering 1, then the mouth portion of the laminate outer covering 1 is welded, whereupon the prismatic lithium ion battery 20 is complete.

The method for manufacturing a prismatic lithium ion battery of the invention will next be described, using Example 1.

### EXAMPLE 1

### Fabrication of Positive Electrode Plate

A positive electrode slurry was prepared by mixing 94 parts by weight of Li(Ni₁_{_{/}}₃Col₁_{_{/}}₃Mn₁_{_{/}}₃)O₂ to serve as the positive electrode active material, three parts by weight of carbon black to serve as conducting agent, and three parts by weight of polyvinylidene fluoride to serve as binding agent, in a solution of N-methyl-2-pyrrolidone (NMP) serving as solvent. Next, this positive electrode slurry was spread over one side or both sides of aluminum foils (thickness 20 μm) serving as the positive electrode substrate 2a. Then the solvent was allowed to dry and the resulting items were pressed by a roller, after which, as shown in FIG. 3, they were cut to width (L1)=145 mm and length (L2)=150 mm, and moreover so that a portion of aluminum foil where no positive electrode active material layer 2b was formed (width L3=30 mm, length L4=20 mm) protruded from one edge of the positive electrode plate 2 as the positive electrode collector tab 4, to complete fabrication of the positive electrode plates 2. The positive electrode plate 2 in which a positive electrode active material layer 2b was formed on both sides of the positive electrode substrate 2a was designated the both-sides-coated positive electrode plate 12a, and the positive electrode plate 2 in which a positive electrode active material layer 2b was formed on one side only of the positive electrode substrate 2a was designated the single-side-coated positive electrode plate 12b. Another item was fabricated by cutting to the same size as the both-sides-coated positive electrode plate 12a and the single-side-coated positive electrode plate 12b a positive electrode substrate 2a with no positive electrode active material layer 2b formed on both sides, which was designated the both-sides-uncoated positive electrode plate 12c.

Fabrication of Negative Electrode Plate

A negative electrode slurry was prepared by mixing 96% by mass of graphite powder to serve as the negative electrode active material, 2% by mass of carboxymethyl cellulose (CMC) and 2% by mass of styrene-butadiene rubber to serve as binding agents, in pure water serving as solvent. This negative electrode slurry was spread over one side or both sides of copper foils (thickness 10 μm) serving as the negative electrode substrate 3a. Then the items were allowed to dry so as to remove the solvent, and the resulting items were pressed by a roller, after which, as shown in FIG. 3, they were cut to width L5=150 mm and length L6=155 mm, and moreover so that a portion of copper foil where no negative electrode active material layer 3b was formed (width L7=70 mm, length L8=20 mm) protruded from one edge of the negative electrode plate 3 as the negative electrode collector tab 5, to complete fabrication of the negative electrode plates 3. The negative electrode plate 3 in which a negative electrode active material layer 3b was formed on both sides of the negative electrode substrate 3a was designated the both-sides-coated negative electrode plate 13a, and the negative electrode plate 3 in which a negative electrode active material layer 3b was formed on one side only of the negative electrode substrate 3a was designated the single-side-coated negative electrode plate 13b. Another item was fabricated by cutting to the same size as the both-sides-coated negative electrode plate 13a and the single-side-coated negative electrode plate 13b a negative electrode substrate 3a with no negative electrode active material layer 3b formed on both sides, which was designated the both-sides-uncoated negative electrode plate 13c.

The amount of positive electrode active material contained in the positive electrode active material layer 2b and the amount of negative electrode active material contained in the negative electrode active material layer 3b were adjusted so that the charging capacity ratio of the positive and negative electrodes (negative electrode charging capacity/positive electrode charging capacity) at the positive electrode active material potential that constitutes the design standard was 1:1.

Preparation of Nonaqueous Electrolyte

A solvent mixture of ethylene carbonate (EC) and diethyl carbonate (DEC) in the proportion 30:70 by volume, into which LiPF₆ was dissolved in the proportion of 1 M (mole/liter), was used as the nonaqueous electrolyte.

Fabrication of Stacked Electrode Assembly

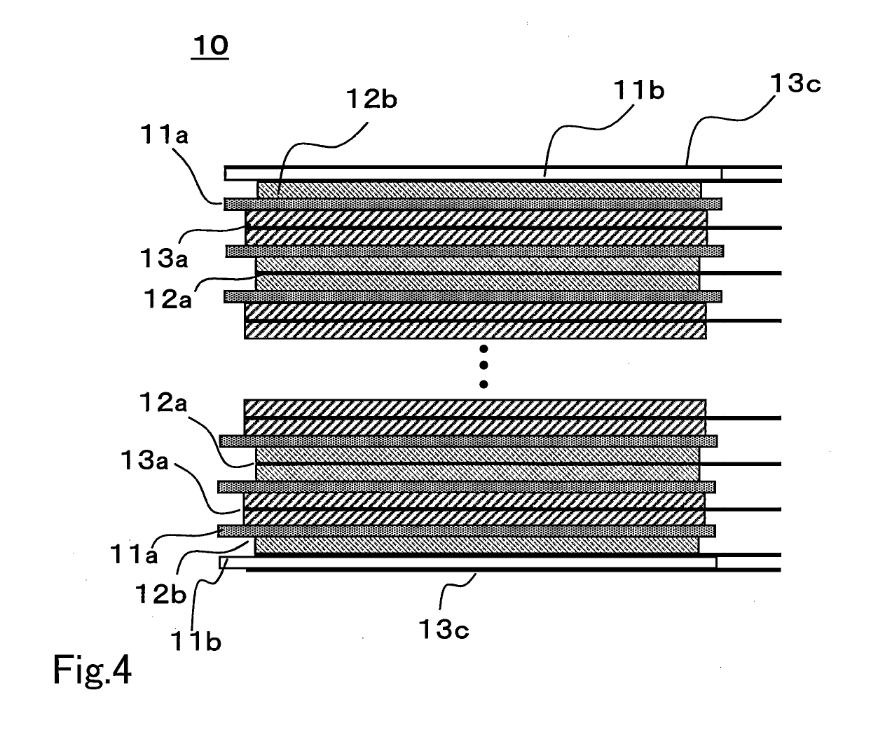

Twenty three both-sides-coated positive electrode plates 12a and twenty four both-sides-coated negative electrode plates 13a were stacked alternately, with separators 11a interposed that were microporous films of polyethylene (width 150 mm, length 155 mm, thickness 15 μm), on one side of which a layer constituted of alumina particles (average particle diameter 1 μm) and polyvinyl alcohol serving as binder was formed (layer thickness 5 μm; proportion of alumina particles to binder 75%:25% by mass). Then, as FIG. 4 shows, a single-side-coated positive electrode plate 12b was disposed, with a separator 11a interposed, on each both-sides-coated negative electrode plate 13a located at the two outermost edges of the stacked electrode assembly, in such a manner that the positive electrode active material layer 2b was positioned toward the center, in the stacking direction, of the stacked electrode assembly. Furthermore, at each of the two outer edges, a both-sides-uncoated negative electrode plate 13c was then disposed, with a separator 11b constituted of microporous film of polyethylene (width 150 mm, length 155 mm, thickness 20 μm) interposed. The resulting item was used as the stacked electrode assembly 10 for Example 1.

The positive electrode tabs 4 of the both-sides-coated positive electrode plates 12a and single-side-coated positive electrode plates 12b were bunched together and connected by ultrasonic welding to a positive electrode terminal 6, onto which a positive electrode tab plastic piece 8 had been stuck beforehand. Likewise, the negative electrode tabs of the both-sides-coated negative electrode plates 13a and both-sides-uncoated negative electrode plates 13c were bunched together and connected by ultrasonic welding to a negative electrode terminal 7, onto which a negative electrode tab plastic piece 9 had been stuck beforehand.

Next, the stacked electrode assembly 10 was inserted between a laminate film, which had been cup-molded so as to house the stacked electrode assembly 10, and a sheet-form laminate film, and three of the outer edges were thermally welded so that the positive electrode terminal 6 and negative electrode terminal 7 protruded from the laminate outer covering 1.

Nonaqueous electrolyte prepared by the method described above was poured in through the edge that had not been thermally welded in the laminate outer covering 1, then the mouth portion of the laminate outer covering 1 was thermally welded, thereby yielding the prismatic lithium ion secondary battery 20 of Example 1.

### EXAMPLE 2

Except for the structure of the stacked electrode assembly 10, the prismatic lithium ion secondary battery 20 of Example 2 was fabricated using the same methods as for that of Example 1. The stacked electrode assembly 10 for Example 2 was fabricated by the following method.

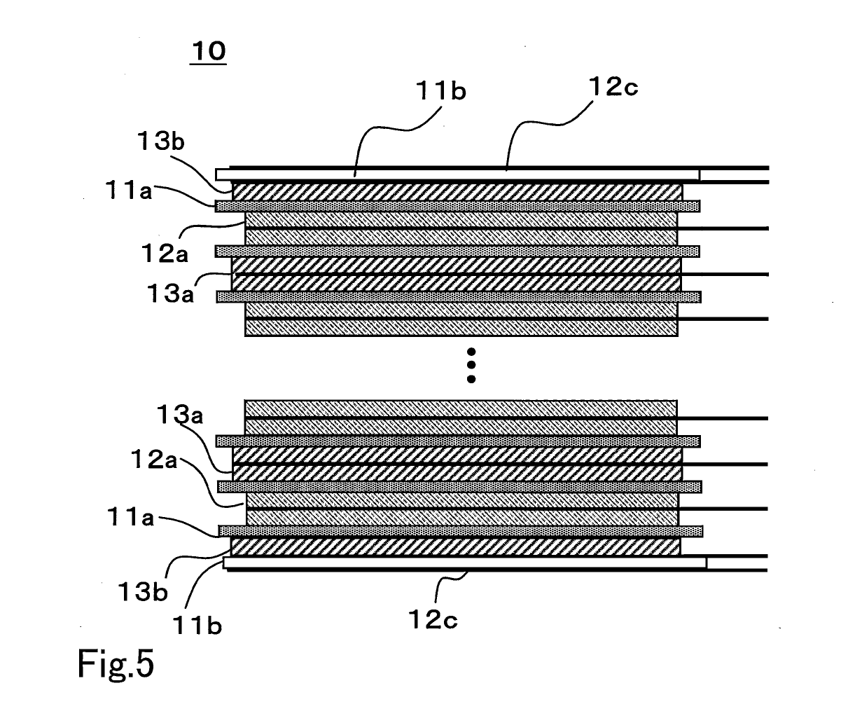

Twenty four both-sides-coated positive electrode plates 12a and twenty three both-sides-coated negative electrode plates 13a were stacked alternately, with separators 11a interposed that were microporous films of polyethylene, on one side of which a layer constituted of alumina particles and polyvinyl alcohol was formed. Then, as FIG. 5 shows, a single-side-coated negative electrode plate 13b was disposed, with a separator 11a interposed, on each both-sides-coated positive electrode plate 12a located at the two outermost edges of the stacked electrode assembly, in such a manner that the negative electrode active material layer 3b was positioned toward the center, in the stacking direction, of the stacked electrode assembly. Furthermore, at each of the two outer edges, a both-sides-uncoated positive electrode plate 12c was then disposed, with a separator 11b constituted of microporous film of polyethylene interposed. The resulting item was used as the stacked electrode assembly 10 for Example 2.

### EXAMPLE 3

Except for the structure of the stacked electrode assembly 10, the prismatic lithium ion secondary battery 20 of Example 3 was fabricated using the same methods as for that of Example 1. The stacked electrode assembly 10 for Example 3 was fabricated by the following method.

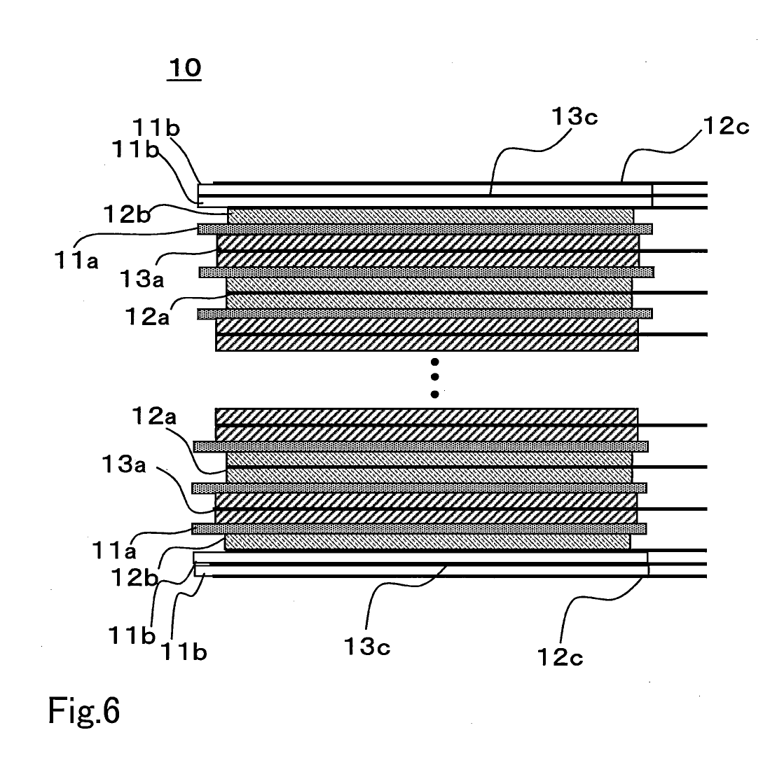

Twenty three both-sides-coated positive electrode plates 12a and twenty four both-sides-coated negative electrode plates 13a were stacked alternately, with separators 11a interposed that were microporous films of polyethylene, on one side of which a layer constituted of alumina particles and polyvinyl alcohol was formed. Then, as FIG. 6 shows, a single-side-coated positive electrode plate 12b was disposed, with a separator 11a interposed, on each both-sides-coated negative electrode plate 13a located at the two outermost edges of the stacked electrode assembly, in such a manner that the positive electrode active material layer 2b was positioned toward the center, in the stacking direction, of the stacked electrode assembly. Furthermore, at each of the two outer edges, a both-sides-uncoated negative electrode plate 13c was then disposed, with a separator 11b constituted of microporous film of polyethylene interposed. Additionally, at each of the two outer edges, a both-sides-uncoated positive electrode plate 12c was disposed, with a separator 11b constituted of microporous film of polyethylene interposed. The resulting item was used as the stacked electrode assembly 10 for Example 3.

### COMPARATIVE EXAMPLE 1

The prismatic lithium ion secondary battery of Comparative Example 1 was fabricated in the same manner as that of Example 1, except that all of the separators in the stacked electrode assembly were separators 11b constituted of microporous film of polyethylene (width 150 mm, length 155 mm, thickness 20 μm).

### COMPARATIVE EXAMPLE 2

The prismatic lithium ion secondary battery of Comparative Example 2 was fabricated in the same manner as that of Example 1, except that all of the separators in the stacked electrode assembly were separators 11a constituted of microporous film of polyethylene, on one side of which a layer constituted of alumina particles and polyvinyl alcohol was formed.

### COMPARATIVE EXAMPLE 3

Except for the structure of the stacked electrode assembly, the prismatic lithium ion secondary battery 20 of Comparative Example 3 was fabricated using the same methods as for that of Example 1. The stacked electrode assembly for Comparative Example 3 was fabricated by the following method.

Twenty three both-sides-coated positive electrode plates 12a and twenty four both-sides-coated negative electrode plates 13a were stacked alternately, with separators 11a interposed that were microporous films of polyethylene, on one side of which a layer constituted of alumina particles and polyvinyl alcohol was formed. The resulting item was used as the stacked electrode assembly for Comparative Example 3.

Note that the separators 11a, microporous films of polyethylene on one side of which a layer constituted of alumina particles and polyvinyl alcohol was formed, that were used in Examples 1 to 3 and Comparative Examples 1 to 3 were all the same. Likewise, the separators 11b, constituted of microporous films of polyethylene, that were used in Examples 1 to 3 and Comparative Examples 1 to 3 were all the same.

The layer constituted of alumina particles and polyvinyl alcohol in the separators 11a used in Examples 1 to 3 and Comparative Examples 2 and 3 was disposed so as to be opposed to the negative electrode plate.

By positioning at the negative electrode plates a layer constituted of alumina particles and polyvinyl alcohol that readily captures electrolyte, ample electrolyte can be made to be present at the negative electrode plates. Hence, the insertability of the lithium ions into the negative electrode active material can be improved and the battery will have superior cycling characteristics.

Evaluation of Safety

The prismatic lithium ion batteries of Examples 1 to 3 and Comparative Examples 1 to 3, fabricated using the methods described above, were charged to 4.3V with constant current of 1 C in a 25° C. environment, then subjected to constant-current and constant-voltage charging applying constant voltage of 4.3V until they reached current of 1/50 C. After that, the prismatic lithium ion batteries were left for 120 minutes under 60° C. conditions. Then tests were conducted in which, also under 60° C. conditions, the central part of the broad surface of the batteries was pierced vertically with a nail made of metal. Abnormality was judged to have occurred if a battery emitted smoke or ignited due to being pierced with the nail. Such test was carried out on three of each of the prismatic lithium ion batteries of Examples 1 to 3 and Comparative Examples 1 to 3. In each case, the test was deemed to be failed if even one out of the three batteries showed abnormality. The test results are set forth in Table 1.

TABLE 1

| | Test result |
|---|---|
| Example 1 | No abnormality |
| Example 2 | No abnormality |
| Example 3 | No abnormality |
| Comparative Example 1 | Abnormality occurred |
| Comparative Example 2 | Abnormality occurred |
| Comparative Example 3 | Abnormality occurred |

As Table 1 shows, emission of smoke, ignition or other abnormality was observed in the nail-piercing tests on the prismatic lithium ion batteries of Comparative Examples 1 to 3, whereas with the prismatic lithium ion batteries of Examples 1 to 3, no emission of smoke, ignition or other abnormality was observed. The reasons for this are considered to be as follows.

The separators interposed between the positive electrode substrates and negative electrode substrates in the prismatic lithium ion batteries of Examples 1 to 3 were the separators 11b, which have no layer containing alumina, and therefore, when short-circuiting due to piercing from the exterior by the nail or other materials occurred, these separators interposed between the positive electrode substrates and negative electrode substrates quickly thermally contracted due to the heat release from the short-circuited portions, and the positive electrode substrates and negative electrode substrates around the short-circuited portions contacted at their surfaces and short-circuit current flowed, so that the battery voltage quickly fell. In addition, the separators interposed between the positive electrode active material layers and the negative electrode active material layers were the separators 11a, which have a layer containing alumina, and therefore even though the short-circuited portions released heat, these separators did not thermally contract and the positive electrode substrates and negative electrode substrates did not directly contact, with the result that passage of the short-circuit current through the active material layers could be curbed. Thus, it is considered that with the prismatic lithium ion batteries of Examples 1 to 3, even if short-circuiting due to piercing by a nail occurs, abnormality such as emission of smoke or ignition can be prevented because the positive electrode substrates and negative electrode substrates will contact at their surfaces and the battery voltage will quickly fall, and moreover the short-circuit current can be curbed from flowing into the active material layers.

With the prismatic lithium ion battery of Comparative Example 3, portions where the positive electrode substrates and negative electrode substrates are opposed with a separator interposed were not provided, and therefore when short-circuiting due to piercing by the nail occurred, there was no contacting between the positive electrode substrates and negative electrode substrates at their surfaces, and it took time for the battery voltage to fall. It is considered that because the short-circuit current could not be curbed from passing through the active material layers, the heat release due to the short-circuit current caused thermolytic reactions in the nonaqueous electrolyte and degradative reactions between the active material and the nonaqueous electrolyte to occur, resulting in emission of smoke, ignition, or other trouble.

With the prismatic lithium ion battery of Comparative Example 1, all of the separators were the separators 11b, which have no layer containing alumina. Hence, when short-circuiting occurred due to the piercing by a nail, the separators interposed between the positive electrode substrates and negative electrode substrates and the separators interposed between the positive electrode active material layers and negative electrode active material layers both thermally contracted. Therefore, it is considered that when the short-circuiting occurred, although the positive electrode substrates and negative electrode substrates contacted at their surfaces, the short-circuit current could not be curbed from passing through the active material layers because the positive electrode active material layers and negative electrode active material layers were directly contacting, and due to the heat release caused by the short-circuit current, thermolytic reactions in the nonaqueous electrolyte and degradative reactions between the active material and the nonaqueous electrolyte occurred, resulting in emission of smoke, ignition, or other trouble.

With the prismatic lithium ion battery of Comparative Example 2, all of the separators were the separators 11a, which have a layer containing alumina. Hence, when short-circuiting occurred due to the piercing by a nail, neither the separators interposed between the positive electrode substrates and negative electrode substrates nor the separators interposed between the positive electrode active material layers and negative electrode active material layers thermally contracted, so that the short-circuit current flowed only via the nail, and it took time for the battery voltage to fall. Therefore, it is considered that ultimately the short-circuit current could not be curbed from passing through the active material layers, and due to the heat release caused by the short-circuit current, thermolytic reactions in the nonaqueous electrolyte and degradative reactions between the active material and the nonaqueous electrolyte occurred, resulting in emission of smoke, ignition, or other trouble.

Thus, with the present invention, a nonaqueous electrolyte secondary battery can be provided that, even if short-circuited by being pierced by a nail or crushed, etc., is prevented from undergoing heat-releasing reactions, igniting or bursting, etc.

Examples of Variants

A portion where a side on which no positive electrode active material layer is formed and a side on which no negative electrode active material layer is formed are opposed with a separator interposed can be formed at one or both of the outermost portions, in the stacking direction, of the stacked electrode assembly, and can additionally be formed in the central region, in the stacking direction, of the stacked electrode assembly.

For example, in the stacked electrode assembly 10 of Example 1, the both-sides-coated positive electrode plate 12a, the separator 11a that has a layer constituted of alumina particles and polyvinyl alcohol formed on it, and the both-sides-coated negative electrode plate 13a, which are contiguously disposed from the outermost portions inward, in the stacking direction, of the stacked electrode assembly, could be replaced with a single-side-coated positive electrode plate 12b, a separator 11b constituted of a microporous film of polyethylene, and a single-side-coated negative electrode plate 13b, respectively, disposed so that the side of the single-side-coated positive electrode plate 12b on which no positive electrode active material layer is formed is opposed to the side of the single-side-coated negative electrode plate 13b on which no negative electrode active material layer is formed, with the separator 11b interposed.

Other Matters

In the foregoing Examples, prismatic lithium ion batteries were fabricated that were structured so as to have a prismatic outer shape, with the stacked electrode assembly 10 being sealed in the laminate outer covering 1, but one could alternatively use a battery can or the like for the outer covering.

The positive electrode active material is not limited to the Li(Ni₁_{_{/}}₃Co₁_{_{/}}₃Mn₁_{_{/}}₃)O₂ used in the Examples. For this material, it will be possible to use lithium cobalt oxide, lithium nickel oxide, lithium manganese oxide, lithium-cobalt-nickel complex oxide, lithium-cobalt-manganese complex oxide, lithium-nickel-manganese complex oxide, or any of the foregoing with one or more of the transition metal elements replaced with Al, Mg, Zr, or the like.

For the negative electrode active material, besides natural graphite, artificial graphite or other black lead, one could use, say, graphite, coke, stannic oxide, metallic lithium, silica, or a mixture of these, or the like, provided that the item used allows insertion/extraction of lithium ions into/from it.

Similarly, the nonaqueous electrolyte is not particularly restricted to that used in the foregoing Examples. As alternative supporting electrolytes that might be used, one can cite, for example, LiBF₄, LiPF₆, LiN(SO₂CF₃)₂, LiN(SO₂C₂F₅)₂, LiPF₆₋ₓ(CnF₂ₙ₊₁)ₓ (where 1<x<6, and n=1 or 2) or the like, either singly or in a mixture of two or more. As regards the concentration of the supporting electrolyte, there is no particular restriction, but a concentration of 0.8 to 1.8 moles per liter of the electrolyte will be preferable. As the solvent species, besides the EC or MEC referred to above, one will preferably use propylene carbonate (PC), γ-butyrolactone (GBL), ethylmethyl carbonate (EMC), dimethyl carbonate (DMC), diethyl carbonate (DEC) or the like carbonate solvent, or more preferably a combination of a cyclic carbonate and a chain carbonate.

The nonaqueous electrolyte in the invention is not limited to an electrolytic solution, and could alternatively be a polymer electrolyte. However, applying this invention to a nonaqueous electrolyte secondary battery that uses a liquid electrolyte will be more advantageous because thermal contraction of the separators will take place smoothly.

For the ceramic layer-containing separators in the invention, it will be possible to use separators that consist solely of a layer that contains ceramic. It will also be possible to provide an insulating layer that contains ceramic on the active material surface of either a positive or a negative electrode and use the resulting item as a separator.

What is claimed is:

1. A nonaqueous electrolyte secondary battery comprising:
a stacked electrode assembly in which positive electrode plates with positive electrode active material layers formed on both sides of a positive electrode substrate and negative electrode plates with negative electrode active material layers formed on both sides of a negative electrode substrate are stacked with separators interposed;
nonaqueous electrolyte; and
an outer covering housing the stacked electrode assembly and the nonaqueous electrolyte,
the stacked electrode assembly containing positive electrode plates in which no positive electrode active material layer is formed on at least one side of the positive electrode substrate and negative electrode plates in which no negative electrode active material layer is formed on at least one side of the negative electrode substrate,
such positive electrode surfaces where no positive electrode active material layer is formed being opposed, with a separator interposed, to such negative electrode surfaces where no negative electrode active material layer is formed,
the separator interposed between the positive electrode active material layers and negative electrode active material layers having a layer containing ceramic, and
the separator interposed between the surfaces where no positive electrode active material layer is formed and the surfaces where no negative electrode active material layer is formed having no layer containing ceramic.

2. The nonaqueous electrolyte secondary battery according to claim 1, wherein a portion where a surface on which no positive electrode active material layer is formed and a surface on which no negative electrode active material layer is formed are opposed with a separator interposed is located at one or both of the outermost portions, in the stacking direction, of the stacked electrode assembly.

3. The nonaqueous electrolyte secondary battery according to claim 2, wherein at the outermost portions, in the stacking direction, of the stacked electrode assembly, an electrode plate of one polarity with an active material layer formed on one side only of the substrate, and an electrode plate of the other polarity with no active material layer formed on both sides of the substrate, are stacked, with a separator interposed, in the order from inward to outward; and the active material layer of the electrode plate of the one polarity with an active material layer formed on one side only of the substrate is opposed, with a separator interposed, to an active material layer formed on an electrode plate of the other polarity that is located inward in the stacking direction of the stacked electrode assembly.

4. The nonaqueous electrolyte secondary battery according to claim 2, wherein at the outermost portions, in the stacking direction, of the stacked electrode assembly, an electrode plate of one polarity with an active material layer formed on one side only of the substrate, an electrode plate of the other polarity with no active material layer formed on both sides of the substrate, and an electrode of the one polarity with no active material layer formed on both sides of the substrate, are stacked, with separators interposed, in the order from inward to outward; and the active material layer of the electrode plate of the one polarity with an active material layer formed on one side only of the substrate is opposed, with a separator interposed, to an active material layer formed on an electrode plate of the other polarity that is located inward in the stacking direction of the stacked electrode assembly.

5. The nonaqueous electrolyte secondary battery according to claim 1, wherein a portion where a surface on which no positive electrode active material layer is formed and a surface on which no negative electrode active material layer is formed are opposed with a separator interposed is located at both of the outermost portions, in the stacking direction, of the stacked electrode assembly.

6. The nonaqueous electrolyte secondary battery according to claim 5, wherein at the outermost portions, in the stacking direction, of the stacked electrode assembly, an electrode plate of one polarity with an active material layer formed on one side only of the substrate, and an electrode plate of the other polarity with no active material layer formed on both sides of the substrate, are stacked, with a separator interposed, in the order from inward to outward; and the active material layer of the electrode plate of the one polarity with an active material layer formed on one side only of the substrate is opposed, with a separator interposed, to an active material layer formed on an electrode plate of the other polarity that is located inward in the stacking direction of the stacked electrode assembly.

7. The nonaqueous electrolyte secondary battery according to claim 5, wherein at the outermost portions, in the stacking direction, of the stacked electrode assembly, an electrode plate of one polarity with an active material layer formed on one side only of the substrate, an electrode plate of the other polarity with no active material layer formed on both sides of the substrate, and an electrode of the one polarity with no active material layer formed on both sides of the substrate, are stacked, with separators interposed, in the order from inward to outward; and the active material layer of the electrode plate of the one polarity with an active material layer formed on one side only of the substrate is opposed, with a separator interposed, to an active material layer formed on an electrode plate of the other polarity that is located inward in the stacking direction of the stacked electrode assembly.

8. The nonaqueous electrolyte secondary battery according to claim 1, wherein the ceramic layer-containing separator is a microporous film made of polyolefin.

9. The nonaqueous electrolyte secondary battery according to claim 1, wherein the ceramic layer-containing separator is provided with a layer composed of ceramic and binder on one or both faces of a microporous film made of polyolefin.

10. The nonaqueous electrolyte secondary battery according to claim 1, wherein the ceramic is one or more items selected from the group consisting of alumina, silica and titania.

11. The nonaqueous electrolyte secondary battery according to claim 1, wherein a portion where a surface on which no positive electrode active material layer is formed and a surface on which no negative electrode active material layer is formed are opposed with a separator interposed is formed also in a central region, in the stacking direction, of the stacked electrode assembly.

12. The nonaqueous electrolyte secondary battery according to claim 1, wherein the outer covering is a laminate outer covering.

13. The nonaqueous electrolyte secondary battery according to claim 1, wherein the nonaqueous electrolyte secondary battery has a capacity of not less than 10 Ah and a thickness of not more than 15 mm.

14. The nonaqueous electrolyte secondary battery according to claim 1, wherein the stacked electrode assembly includes 10 or more positive electrode plates with positive electrode active material layers formed on both sides of the positive electrode substrate, and 10 or more negative electrode plates with negative electrode active material layers formed on both sides of the negative electrode substrate.

15. The nonaqueous electrolyte secondary battery according to claim 1, wherein the ceramic layer-containing separator is an item in which a layer composed of ceramic and binder is provided on one side only of a microporous film of polyolefin and the layer composed of ceramic and binder is disposed so as to be opposed to the negative electrode active material layers of the negative electrode plates.
